(19) United States
(12) Patent Application Publication
(10) Pub. No.: US 2022/0351440 A1
(43) Pub. Date: Nov. 3, 2022

(54) ANIMATION PRODUCTION SYSTEM

(71) Applicants: XVI Inc., Chuo-ku (JP); Avex Technologies Inc., Minato-ku (JP)

(72) Inventors: Yoshihito KONDOH, Chuo-ku (JP); Masato MUROHASHI, Tokyo (JP)

(21) Appl. No.: 16/977,057

(22) PCT Filed: Sep. 24, 2019
(86) PCT No.: PCT/JP2019/037409

§ 371 Date: Aug. 31, 2020

(51) Int. Cl. G06T 13/40

(52) U.S. Cl. CPC G06T 13/40

(57) ABSTRACT

[Technical Problem] To enable to shoot animations in a virtual space. [Solution to Problem] An animation production system comprises a plurality of virtual cameras for shooting characters placed in a virtual space; a user input detection unit that detects an input of user from at least one of a head mounted display and a controller which the user mounts; and a camera control unit that receives a selection of the camera to be operated and controls the selected camera in response to the input.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem is an animation production system comprises a plurality of virtual cameras for shooting characters placed in a virtual space; a user input detection unit that detects an input of user from at least one of a head mounted display and a controller which the user mounts; and a camera control unit that receives a selection of the camera to be operated and controls the selected camera in response to the input.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating an example of a functional configuration of an image producing device 310 according to the present embodiment;

FIG. 8 is a diagram illustrating a photographing state of a camera 3 according to the present embodiment;

FIG. 9 is a diagram illustrating a state in which the camera 3 is switched;

FIG. 10 is a diagram illustrating a flow of a photographing process in an animation production system 300 according to the present embodiment.

### DESCRIPTION OF EMBODIMENTS

The contents of embodiments of the present invention will be described with reference. The present invention includes, for example, the following configurations.

### Item 1

An animation production system comprising:

a plurality of virtual cameras for shooting characters placed in a virtual space;

a user input detection unit that detects an input of user from at least one of a head mounted display and a controller which the user mounts; and

a camera control unit that receives a selection of the camera to be operated and controls the selected camera in response to the input.

### Item 2

The animation production system according to claim 1,

further comprising an image data storage unit that stores an operation of a character in the virtual space, and

wherein the camera control unit controls the camera while playing back the operation of the character.

### Item 3

The animation production system according to claim 2, further comprising:

a character control unit that receives a selection of the character to be operated and controls the selected character in response to the input; and

an image generating unit that registers the operation of the character in the image data storage unit.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### OVERVIEW

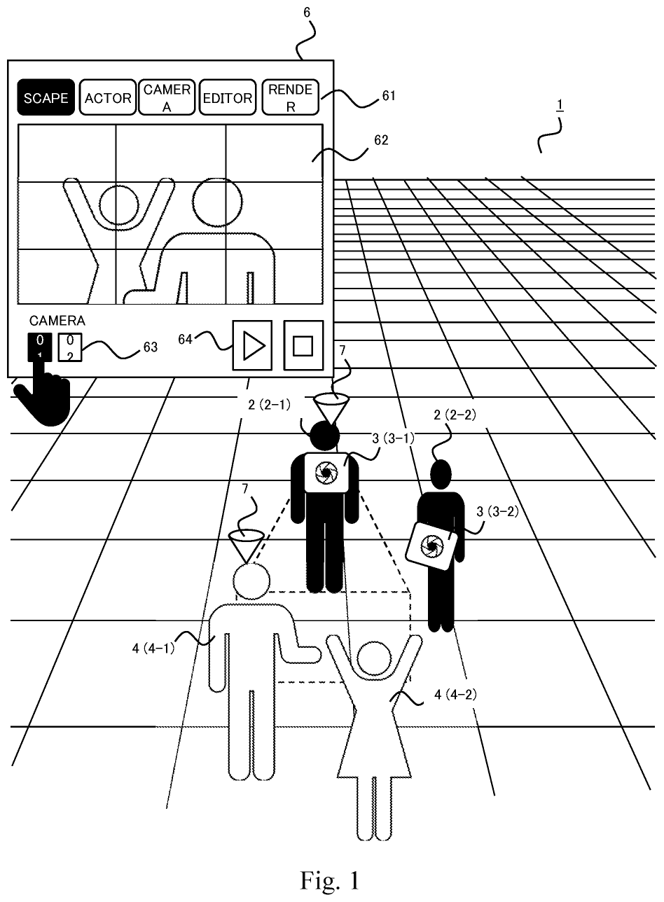

FIG. 1 is a diagram illustrating an example of a virtual space displayed on a head mount display (HMD) mounted by a user in an animation production system 300 according to the present embodiment. The animation production system 300 according to the present exemplary embodiment is intended to create an animation by placing a virtual character 4 and a virtual camera 3 in a virtual space 1 and taking a character 4 using a camera 3.

A photographer 2 (a photographer character) is disposed in the virtual space 1, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. Within virtual space 1, a plurality of cameras 2 (in the example of FIG. 1, cameras 2-1 and 2-2) may be disposed, and cameras 2-1 and 2-2 may be switched to switch video from camera 2 which is employed in the final animation.

In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e. g., characters 4-1 and 4-2).

In this manner, in the animation production system 300 of the present embodiment, one can play a number of roles (roles). In addition, since the camera 2 can be virtually operated as the photographer 2, natural camera work can be realized and the representation of the movie to be shot can be enriched.

### General Configuration

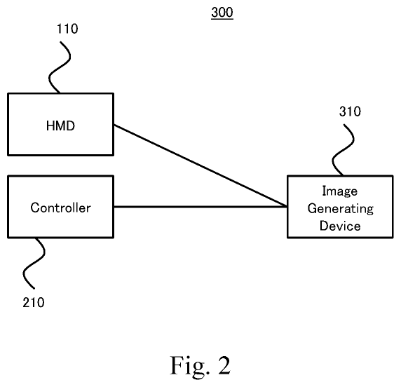

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### HMD 110

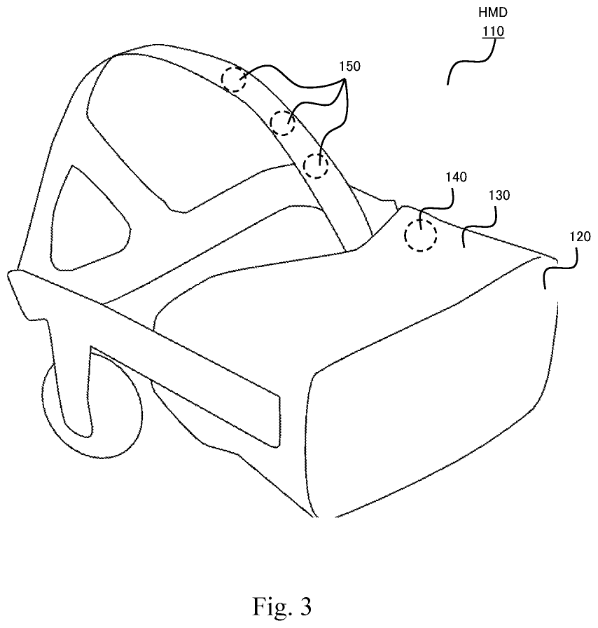

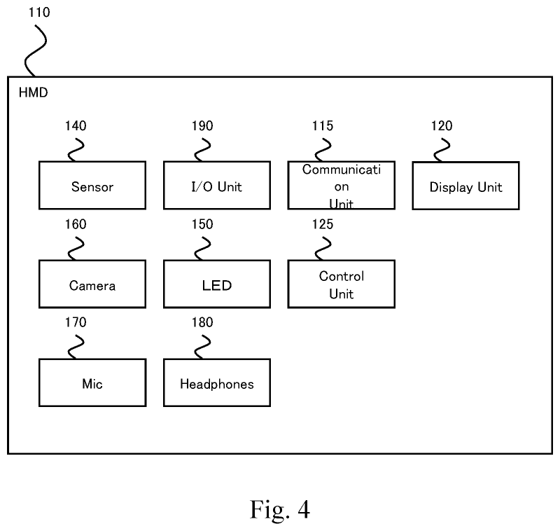

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e. g., infrared light LEDs, visible light LEDs). A camera (e. g., an infrared light camera, a visible light camera) installed outside the HMD 110 (e. g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

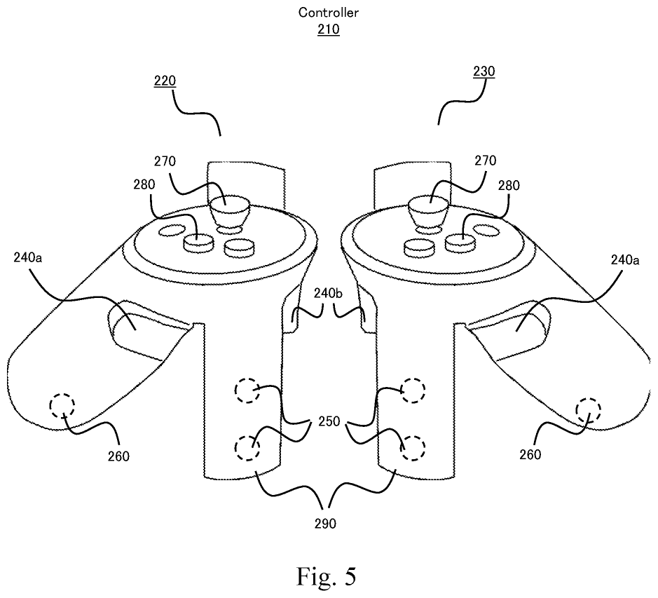

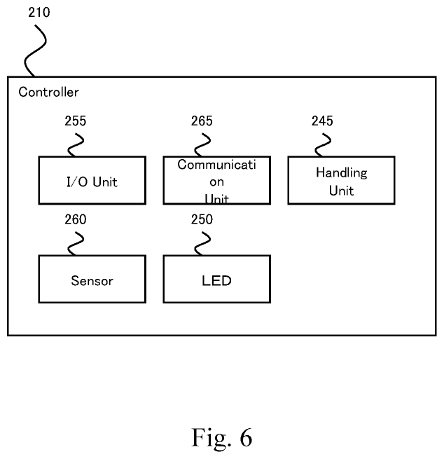

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### Image Generator 310

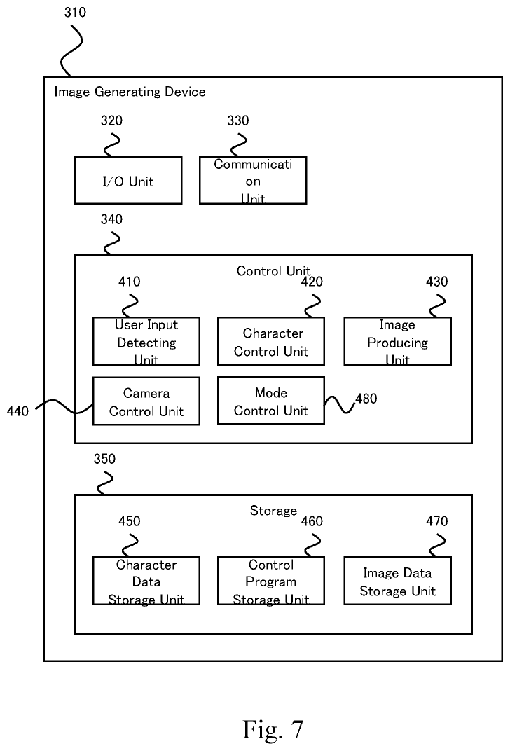

FIG. 7 is a diagram illustrating an example of a functional configuration of an image producing device 310 according to this embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding movement of the user's head, user speech, and movement and operation of the controller, a character control unit 420 that executes a control program stored in the control program storage unit 460 for a character data storage unit 450 of the storage unit 350, a camera control unit 440 that controls a virtual camera 3 disposed in the virtual space 1 in accordance with a character control unit 460, a mode control unit 480 that changes the control mode of the system, and an image producing unit 430 that generates an image in which the camera 3 captures the virtual space 1 based on a character control mode. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings (e. g., the position within the virtual space 1 of the camera 3, the shooting direction, the focus position, and the zoom of the camera 3) with respect to the camera 3 according to the movement of the character 4 by hand.

The storage unit 350 stores in the aforementioned character data storage unit 450 information related to the character 4, such as the attribute of the character 4, as well as the image data of the character 4. The control program storage unit 460 controls the operation and expression of the character 4 in the virtual space and stores a program for controlling an object such as the camera 3. The image data storage unit 470 stores the image generated by the image producing unit 430.

### Control Panel 6

The control mode of the animation production system 300 is set by the mode control unit 480. It is possible to set the birds-eye view mode at startup. The menu screen, etc. may be displayed at startup. The user can change the control mode by operating the control panel 6. As shown in FIG. 1, the control panel 6 is disposed in the virtual space 1. The control panel 6 can be located in a free position by user operation. The mode control portion 480 may move the control panel 6 in response to movement of the controller 210 by a user, for example, moving the fingers near the end of the control panel 6 and depressing the trigger button 240 to grasp the control panel 6 while moving the controller 210. It is preferable that the control panel 6 be placed in a position that is easy to see at any time, from the user (performer) possessed by the character 4, from the camera man 2, or from a bird's-eye perspective. Accordingly, when a user has a possession of a character 4, he/she can perform a preview while looking at the control panel 6, or when arranging a background set from a bird's-eye perspective, he/she can install the camera while checking how the background appears relative to the camera 3.

The control panel 6 includes a mode switching button 61 for changing the control mode, a camera image display unit 62 for displaying the camera image captured by the camera 3, and a camera switching button 63 for switching the camera 3. In the example of FIG. 1, the mode switching button 61 includes at least a ““SCAPE”” button for switching to a bird's-eye view mode that takes a bird's-eye view of the virtual space 1, an ““ACTOR”” button for switching to a performance mode in which the character 4 is possessed and performed, and a ““CAMERA”” button for switching to a camera mode in which the camera 3 is operated by the camera 2.

### Camera Shooting

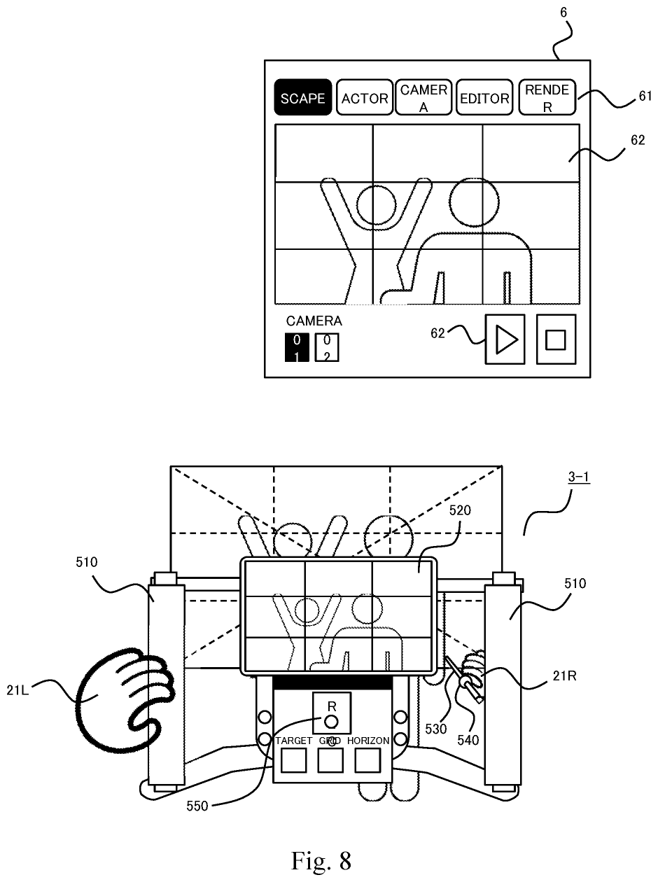

FIG. 8 is a diagram illustrating a shooting condition of the camera 3 according to the present embodiment. In FIG. 8, it is assumed that the user's possession target (to be operated) is set to Cameraman 2.

Each of the cameras 3 is provided with a handle 510 on both sides. The character control unit 420 (which may be the camera control unit 440; the same shall apply hereinafter) controls the movement of the camera man 2 by hand 21 in response to an input from the controller 210. For example, the position of the hand 21 is controlled in response to the position of the controller 210 and the grasping action of the hand 21 is controlled in response to the pushing of the trigger button 240. When the user's hand 21 grips the handle 510, the camera control unit 440 changes the position, posture (shooting direction), and focus position of the camera 3 according to the movement of the hand 21. The image displayed on the display unit 510 changes depending on the position, position, and focal position of the camera 3. That is, in the virtual space 1, the user can implement the camera work of the camera 3 by operating the controller 210.

A display unit 520 is provided in the camera 3. In the display unit 520, an image captured by the camera 3 in the virtual space 1 is displayed. FIG. 8 illustrates an example of a camera 3-1 positioned in front of a character 4, and a display portion 520 captures and displays what is within the shooting range of camera 3-1. The user can operate the camera 3 while checking the image displayed on the display unit 520. That is, the photographer 2 can operate the camera 3 in the virtual space 1 without any actual camera work.

A slider 540 is also disposed on the camera 3. The user may move the hand 21 to grasp the slider 540 and move the slider 540 along the rail 530. In this embodiment, the race 530 is provided between the camera 3 and the subject to be shot (e. g., the character 4) and extends parallel to the anteroposterior direction (a direction parallel to the shooting direction of the camera 3 in which the shooting direction of the camera 3 is forward). The camera control unit 440 may adjust the zoom of the camera 3 in response to movement of the slider 540. For example, when the camera control unit 440 is moved so that the slider 540 is closer to the shooting object (in the shooting direction of the camera 3), the magnification ratio of the zoom of the camera 3 can be increased, and when the slider 540 is moved so that the slider 540 is closer to the camera 3 (in the direction opposite to the shooting direction of the camera 3), the magnification ratio of the zoom of the camera 3 can be reduced. The direction in which the slider 540 moves (the longitudinal direction of the rail 530) may not be parallel to the photographing direction of the camera, for example, the vertical direction or the left-right direction. The slider 540 may also be a rotational or spiral action instead of a linear operation.

A recording button 550 is located near the display 520 of the camera 3. When the recording button 550 is pressed, the image producing unit 430 records the image taken by the camera 3 as a moving image in the image data storage unit 470, and when the recording button 550 is pressed again, the recording by the image producing unit 430 ends. Movies stored in the image data storage unit 470 are stored as data (action data) indicating time-series changes in the position and movement of the character 4 and other objects, such as the movement of the bone of the character 4.

The control panel 6 is also disposed in the virtual space 1 during operation of the camera 3. When the camera 3 is taken and the movie data is registered in the image data storage unit 470, a playback button 64 is provided in the control panel 6. When the playback button 64 is pressed by operating the finger of the camera man 2, the movie is played back based on the action data registered in the image data storage unit 470. As described above, the action data is stored in the image data storage unit 470. Accordingly, in the animation production system 300 of the present embodiment, the operation of the character 4 is reproduced by pressing the playback button 64. Accordingly, the user can record a state in which the character 4 is acting (operating) by operating the camera 3 under the possession of the photographer 2.

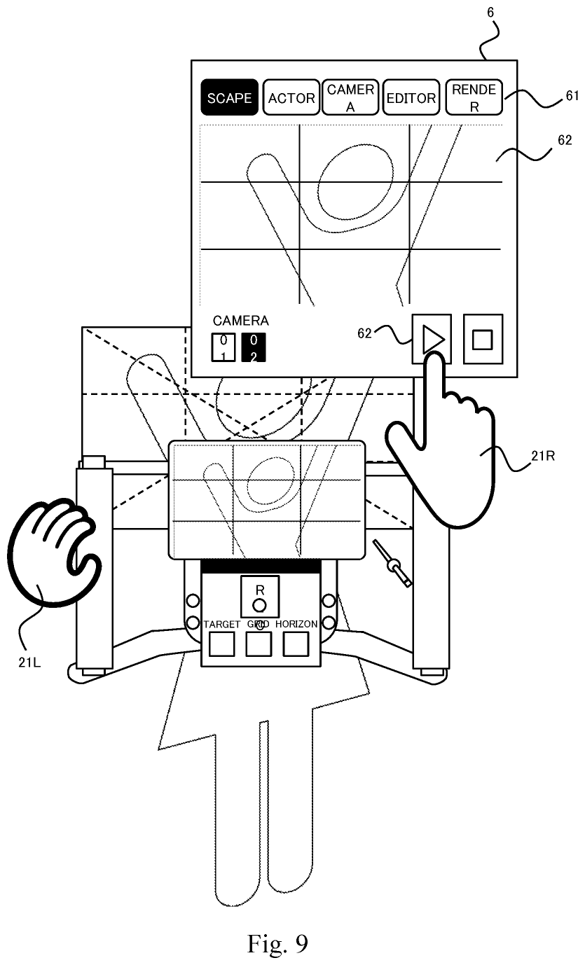

In addition, the user can switch the camera 3 and shoot. FIG. 9 is a diagram illustrating a state in which the camera 3 is switched. In the example of FIG. 9, the state of switching from the camera 3-1 illustrated in FIG. 8 to the camera 3-2 described above is illustrated. As shown in FIG. 1, camera 3-2 is positioned closer to character 4-2 than camera 3-1, and in the example of FIG. 9, the character 4-2 is shown being shot with a zoom-up. Here, by pressing the playback button 64 of the control panel 6 again, the user can take a photograph of a state in which the character 4 performs the same operation as the shooting of the camera 3-1 using the camera 3-2.

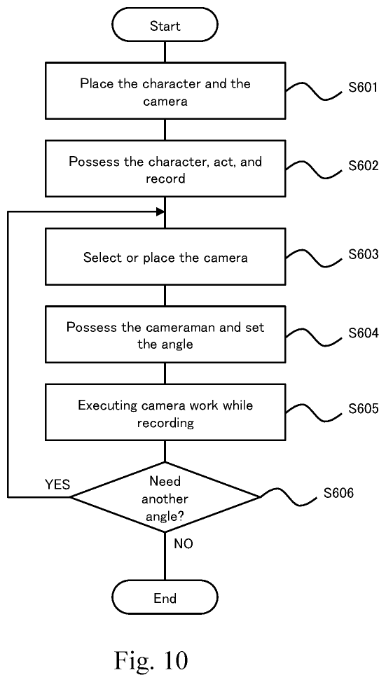

FIG. 10 is a diagram illustrating a flow of a photographing process in the animation production system 300 according to the present embodiment.

The user disposes the character 4 and the camera 3 in the virtual space 1 with the virtual space 1 as shown in FIG. 1 in a bird's-eye view (S601). Of course, objects other than character 4 or camera 3 (e. g., background, small objects, etc.) may be arranged.

The user operates the character 4 by possessing the character 4, performs the performance of the character 4, and records the performance thereof (S602). As described above, the recording here is not limited to the moving image through the camera, but indicates that the operation of the character 4 (such as the position and operation of the bone) is recorded. Therefore, the position or angle of the camera 3 may not be considered for the first time.

The user may newly arrange the camera 3 or select one of the cameras 3 disposed in the virtual space 1 (S603) and set the position and angle of the camera 3 to be operated by the selected photographer 2 (S604). For example, by pressing the regeneration button 64 of the control panel 6, the user plays the operation of the character 4 based on the action data and takes a photograph of the operation of the acting character 4 using the camera 3 (S605). If you want to take pictures from another angle (S606: YES), repeat the process from step S603.

As described above, the user may take a performance possessed by the character 4 using one or more cameras 3.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space

2 cameraman

3 cameras

4 characters

6 control panel

61 Mode Switching Button

62 Camera image display

63 camera switch button

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

320 I/O portion

330 communication section

340 controller

350 storage

410 User Input Detector

420 character control unit

430 Image Generator

440 Camera Control

450 character data storage section

460 Program Storage

470 Image Data Storage

480 mode controller

510 handle

520 display

530 rail

540 slider

550 recording button

1. An animation production system comprising:
a plurality of virtual cameras for shooting characters placed in a virtual space;
a user input detection unit that detects an input of user from at least one of a head mounted display and a controller which the user mounts; and
a camera control unit that receives a selection of the camera to be operated and controls the selected camera in response to the input.

2. The animation production system according to claim 1,
further comprising an image data storage unit that stores an operation of a character in the virtual space, and
wherein the camera control unit controls the camera while playing back the operation of the character.

3. The animation production system according to claim 2, further comprising:
a character control unit that receives a selection of the character to be operated and controls the selected character in response to the input; and
an image generating unit that registers the operation of the character in the image data storage unit.
